(19) United States
(12) Patent Application Publication
(10) Pub. No.: US 2017/0241385 A1
(43) Pub. Date: Aug. 24, 2017

(54) FUEL SUPPLY DEVICE

(71) Applicant: DENSO CORPORATION, Kariya-city, Aichi-pref (JP)

(72) Inventors: Yoshishige TAKAYAMA, Kariya-city (JP); Toshihiko MURAMATSU, Kariya-city (JP); Shin NISHIYA, Kariya-city (JP)

(73) Assignee: DENSO CORPORATION, Kariya-City, Aichi-Pref. (JP)

(21) Appl. No.: 15/519,612

(22) PCT Filed: Nov. 3, 2015
(86) PCT No.: PCT/JP2015/005515

§ 371 Date: Apr. 17, 2017

(30) Foreign Application Priority Data
Nov. 11, 2014 (JP) 2014-229157

(51) Int. Cl. F02M 37/10

(52) U.S. Cl. CPC F02M 37/10; F02M 2200/9038

(57) ABSTRACT

A fuel supply device is provided with a tank lid closing a through-hole in a tank wall of a fuel tank and sends fuel in the fuel tank to an outside of the fuel tank when fixed to the fuel tank by interposing the tank lid between the tank wall and a fixing member. The tank lid has a lid-side contact surface portion which is in an exposed outer surface exposed outside the fuel tank and is in contact with a fixed-side contact surface portion of the fixing member screwed into the tank wall along an outer circumferential portion of the tank lid. The lid-side contact surface portion is provided with an acid-resistant coating film set with surface free energy different from surface free energy set to the fixed-side contact surface portion.

This application is based on Japanese Patent Application No. 2014-229157 filed on Nov. 11, 2014, the disclosure of which is incorporated herein by reference.

### TECHNICAL FIELD

The present disclosure relates to a fuel supply device sending fuel in a fuel tank to an outside of the fuel tank.

### BACKGROUND ART

A fuel supply device provided with a tank lid closing a through-hole in a tank wall of a fuel tank has been used extensively.

A type of such a fuel supply device disclosed in Patent Literature 1 is fixed to the fuel tank by interposing the tank lid between the tank wall and a fixing member. In particular, an exposed outer surface of the tank lid to be exposed outside the fuel tank is made of acid-resistant resin to enhance durability.

### PRIOR ART LITERATURES

### Patent Literature

Patent Literature 1: U.S. Pat. No. 7,255,092

### SUMMARY OF INVENTION

In the fuel supply device disclosed in Patent Literature 1, the tank lid is formed by laminating a layer of acid-resistant resin on a layer of base resin by means of two-shot molding. According to the molding method of the tank lid as above, however, a primary molded article often breaks during secondary molding, for example, in a case where a structure of the tank lid is made more complex by providing a fuel supply tube and a fuel connector. It thus becomes difficult to manage an injection pressure and a compression pressure of resin during the secondary molding and productivity deteriorates.

In order to overcome such an inconvenience, the inventors have been studying a technique to enhance not only durability but also productivity by providing an acid-resistant coating film to an exposed outer surface of the tank lid by a method relatively as easy as applying a coating material. In addition, the inventors have been studying a technique to further increase a productivity enhancing effect by making a tank-lid fixing work easier with a configuration to screw the fixing member into the tank wall along an outer circumferential portion of the tank lid.

As an outcome of assiduous studies by the inventors, it is discovered that inconveniences as follows occur in a case where the fixing member is screwed into the tank wall along the outer circumferential portion of the tank lid provided with the acid-resistant coating film on the exposed outer surface. The inconveniences arise from a fact that the acid-resistant coating film is firmly fixed to the fixing member when the fixing member is screwed into the tank wall depending on materials of the fixing member and the acid-resistant coating film, in which case a slave rotation of the tank lid to the fixing member occurs. When such a slave rotation occurs, a fastening force of the tank lid becomes insufficient between the tank wall and the fixing member or the tank lid may not stay at a proper position in a circumferential direction and an up-down direction. When a fastening force of the tank lid becomes insufficient, the fixing member becomes loose from the tank wall. In such a case, fuel vapor may possibly leak from a clearance between the inclined tank lid and the through-hole. When the tank lid does not stay at a proper position, other elements forming the fuel supply device also undergo displacement in position. In such a case, a desired device property may possibly be lost.

The present disclosure has an object to provide a fuel supply device not only increasing durability and productivity, but also restricting leakage of fuel vapor and ensuring a device property.

According to a first aspect of the present disclosure, the fuel supply device is provided with a tank lid closing a through-hole in a tank wall of a fuel tank and sends fuel in the fuel tank to an outside of the fuel tank when fixed to the fuel tank by interposing the tank lid between the tank wall and a fixing member. The tank lid has a lid-side contact surface portion which is in an exposed outer surface exposed outside the fuel tank and is in contact with a fixed-side contact surface portion of the fixing member screwed into the tank wall along an outer circumferential portion of the tank lid. The lid-side contact surface portion is provided with an acid-resistant coating film set with surface free energy different from surface free energy set to the fixed-side contact surface portion.

According to the fuel supply device, the acid-resistant coating film is provided to the tank lid at least on the lid-side contact surface portion in the surfaces making up the exposed outer surface exposed outside the fuel tank. Hence, high durability can be ensured at high productivity. Further, the lid-side contact surface portion provided with the acid-resistant coating film is in contact with the fixed-side contact surface portion of the fixing member screwed into the tank wall along the outer circumferential portion of the tank lid. By taking such contact into consideration, surface free energy different from surface free energy set to the fixed-side contact surface portion is set to the acid-resistant coating film. Owing to the surface free energy set as above, the acid-resistant coating film provided to the lid-side contact surface portion is restricted from firmly fixing to the fixed-side contact surface portion when the fixing member is screwed into the tank wall. Hence, a slave rotation of the tank lid to the fixing member can be avoided. Consequently, a fastening force of the tank lid can be ensured between the tank wall and the fixing member, which can in turn restrict leakage of fuel vapor from a clearance between the tank lid and the through-hole. In addition, by fixing the tank lid at a proper position in a circumferential direction and an up-down direction and thereby restricting positional displacement of the other elements forming the fuel supply device, a desired device property can be ensured.

According to a second aspect of the present disclosure, the acid-resistant coating film is provided in the lid-side contact surface portion at an interposing point set between the tank wall and the fixing member, in the tank lid.

According to the fuel supply device, a fastening force of the tank lid directly acts on the tank lid at the interposing point set between the tank wall and the fixing member. Hence, the acid-resistant coating film provided to the lid-side contact surface portion at the interposing point is pressed against the fixed-side contact surface portion of the fixing member due to a fastening force generated when the fixing member is screwed into the tank wall. However, even when the acid-resistant coating film is pressed against the fixed-side contact surface portion set with different surface free energy, the acid-resistant coating film is hardly fixed firmly to the fixed-side contact surface portion. A slave rotation of the tank lid to the fixing member can be thus avoided. Consequently, leakage of fuel vapor from a clearance between the tank lid and the through-hole can be restricted and also a desired device property can be ensured by properly locating the elements forming the fuel supply device.

### BRIEF DESCRIPTION OF DRAWINGS

The above and other objects, features and advantages of the present disclosure will become more apparent from the following detailed description made with reference to the accompanying drawings. In the drawings:

FIG. 1 is a perspective view in partial cross section showing a fuel supply device according to one embodiment;

FIG. 2 is a sectional view showing a tank lid of FIG. 1;

FIG. 3 is an enlarged sectional view of FIG. 2;

FIG. 4 is a sectional view showing one example of a modification of the configuration of FIG. 2;

FIG. 5 is a sectional view showing another example of the modification of the configuration of FIG. 2;

FIG. 6 is a sectional view showing still another example of the modification of the configuration of FIG. 2.

### DESCRIPTION OF EMBODIMENTS

Hereinafter, one embodiment of the present disclosure will be described according to the drawings.

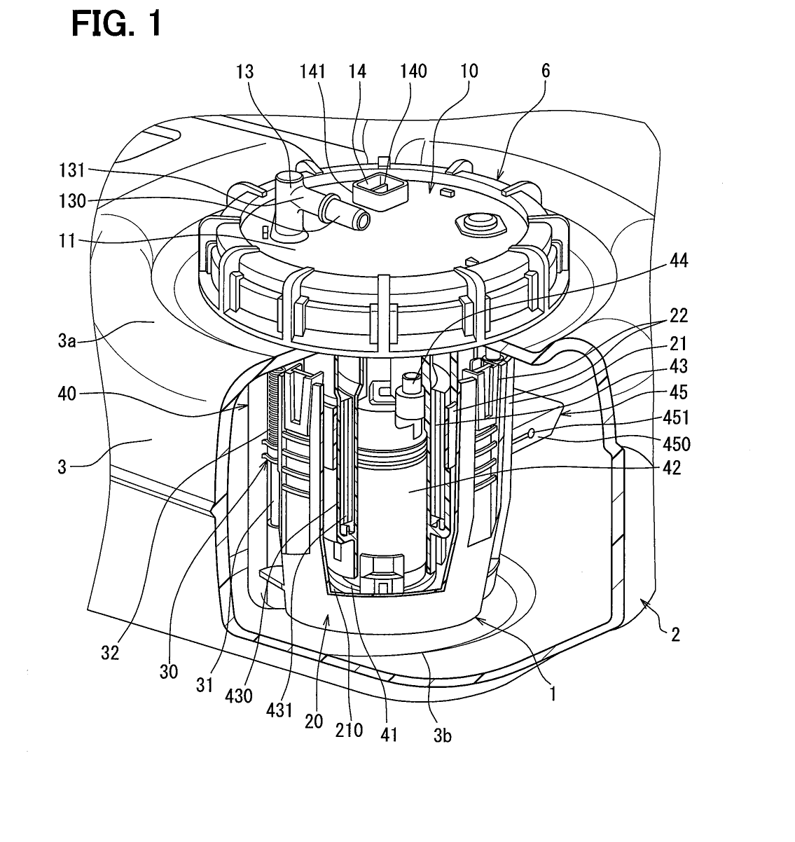

As is shown in FIG. 1, a fuel supply device 1 according to one embodiment of the present disclosure is equipped to a fuel tank 2 of a vehicle. The fuel supply device 1 supplies fuel in the fuel tank 2 to an internal combustion engine on an outside of the fuel tank 2 in the vehicle. The internal combustion engine supplied with fuel by the fuel supply device 1 may be either a gasoline engine or a diesel engine.

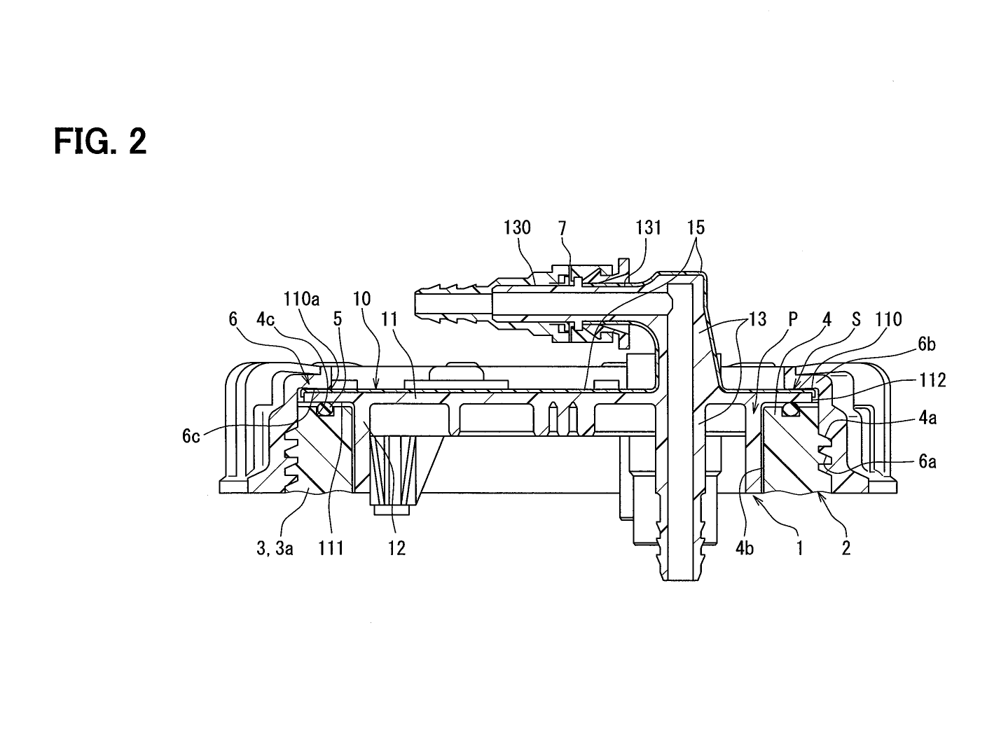

The fuel tank 2 equipped with the fuel supply device 1 is made of a resin material or a metal material and formed in a hollow shape so as to store fuel to be supplied to the internal combustion engine. A ceiling wall 3a of a tank wall 3 of the fuel tank 2 to be located above fuel has a fixing seat portion 4 protruding upward in a circular cylindrical shape as is shown in FIG. 2. An outer peripheral surface of the fixing seat portion 4 forms a tank-side thread portion 4a in a male screw shape. An inner peripheral surface of the fixing seat portion 4 defines a through-hole 4b penetrating through the fixing seat portion 4 from top to bottom. A holding recess portion 4c of an annular groove shape is provided to a top surface of the fixing seat portion 4 coaxially with the tank-side thread portion 4a and the through-hole 4b. The holding recess portion 4c holds an elastic member 5 made of a rubber material and formed in a circular ring shape inside.

The fuel supply device 1 is fixed to the fuel tank 2 configured as above with a fixing member 6 shown in FIGS. 1 and 2. The fixing member 6 is made of a resin material and formed in a circular cylindrical shape. As is shown in FIG. 2, an inner peripheral surface of the fixing member 6 forms a fixed-side thread portion 6a in a female screw shape to be coaxially screwed into the tank-side thread portion 4a. An inner flange portion 6b of an annular flat-plate shape is provided to a top surface of the fixing member 6 so as to protrude radially inward.

The following will describe a fundamental configuration of the fuel supply device 1. As is shown in FIG. 1, the fuel supply device 1 includes a tank lid 10, a sub-tank 20, an adjustment mechanism 30, and a pump unit 40. The elements 20, 30, and 40 forming the fuel supply device 1 other than the tank lid 10 are stored in the fuel tank 2.

As are shown in FIGS. 1 and 2, the tank lid 10 has a lid main body 11, a reinforcing rib 12, a fuel supply tube 13, and an electrical connector 14. The lid main body 11 is made of a resin material and formed in a circular plate shape. The lid main body 11 is interposed between the fixing seat portion 4 and the inner flange portion 6b on an outer peripheral side of the reinforcing rib 12 shown in FIG. 1. When interposed in the manner as above, the lid main body 11 is fixed to the fixing seat portion 4 and therefore closes the through-hole 4b entirely from above. In addition, a top surface 110 of the lid main body 11, which is exposed outside the fuel tank 2 as an exposed outer surface, is in contact with the inner flange portion 6b. Further, a bottom surface 111 of the lid main body 11 is in contact with the elastic member 5 on an opposite side to the inner flange portion 6b. A space between the lid main body 11 and the fixing seat portion 4 is thus sealed with the elastic member 5 in an elastically deformed state.

The reinforcing rib 12 is made of a resin member and formed integrally with the lid main body 11. The reinforcing rib 12 reinforces the lid main body 11 by protruding downward from the lid main body 11 in a circular cylindrical shape. The reinforcing rib 12 locates the lid main body 11 with respect to the fixing seat portion 4 when coaxially fit into the through-hole 4b from above.

As are shown in FIGS. 1 and 2, the fuel supply tube 13 is made of a resin material and formed integrally with the lid main body 11. The fuel supply tube 13 is connected to a fuel filter 43 of the pump unit 40 by protruding downward from the lid main body 11 in a circular cylindrical shape. The fuel supply tube 13 is used for a connection to the internal combustion engine by protruding upward from the lid main body 11 in a circular cylindrical shape like an inverted L. The upward protruding portion of the fuel supply tube 13 is provided in such a manner that an outer peripheral surface 130 at a tip end is covered by a coupling connector 7 to the internal combustion engine whereas an outer peripheral surface 131 at a base is exposed outside the fuel tank 2 as the exposed outer surface.

The electrical connector 14 is made of a resin material and, as is shown in FIG. 1, formed integrally with the lid main body 11. Multiple metal terminals 140 are buried in the electrical connector 14 by means of insert resin molding. The electrical connector 14 holds each of the metal terminals 140 to be electrically connectable to a fuel pump 42 and a liquid-level sensor 45 both included in the pump unit 40 by protruding downward from the lid main body 11 in a rectangular cylindrical shape. The electrical connector 14 also holds each of the metal terminals 140 to be electrically connectable to an external control circuit by protruding upward from the lid main body 11 in a rectangular cylindrical shape. The upward protruding portion of the electrical connector 14 is provided in such a manner that an outer peripheral surface 141 is exposed outside the fuel tank 2 as the exposed outer surface.

The sub-tank 20 has a tank main body 21 and a pump retainer 22. The tank main body 21 is made of a resin material and formed in a circular cylindrical shape with a bottom. The tank main body 21 is disposed in the fuel tank 2 and located on a bottom wall 3b of the tank wall 3. Fuel transferred from inside the fuel tank 2 is stored in the tank main body 21. The pump retainer 22 is made of a resin material and formed in a frame shape. The pump retainer 22 is attached to an opening of the tank main body 21.

The adjustment mechanism 30 has a support pillar 31 and a pushing member 32. The support pillar 31 is made of a metal material and formed in a circular cylindrical shape. The support pillar 31 is attached to the lid main body 11 at an upper end. The support pillar 31 is supported on the tank main body 21 present below the upper end of the support pillar 31 and allowed to slide up and down. The pushing member 32 is made of a metal material and formed in a coiled spring shape. The pushing member 32 is disposed coaxially with the support pillar 31 on an outer peripheral side and interposed between the lid main body 11 and the tank main body 21. The pushing member 32 interposed in the manner as above presses a bottom wall 210 of the tank main body 21 against the bottom wall 3b of the fuel tank 2 by exerting a force toward the sub-tank 20.

The pump unit 40 has a suction filter 41, the fuel pump 42, the fuel filter 43, a pressure regulator 44, and the liquid-level sensor 45. The suction filter 41 is disposed on the bottom wall 210 in the tank main body 21. The suction filter 41 is connected to an inlet of the fuel pump 42. The suction filter 41 filters out large foreign matter from fuel to be withdrawn into the fuel pump 42 from the sub-tank 20.

The fuel pump 42 is disposed in the tank main body 21 and located above the suction filter 41. The fuel pump 42 is electrically connected to the metal terminals 140 of the electrical connector 14 via a bendable flexible wire. The fuel pump 42 electrically connected in the manner as above operates under a control of the external control circuit and discharges fuel withdrawn through the suction filter 41 in a pressurized state.

The fuel filter 43 is disposed so as to be on both inside and outside of the tank main body 21 and located on the outer peripheral side of the fuel pump 42. The fuel filter 43 includes a filter element 431, such as a honeycomb filter element, and a filter case 430 and formed by storing the former in the latter. The filter case 430 is held by the pump retainer 22. The filter case 430 is connected to an outlet of the fuel pump 42 on an upstream side and connected to the fuel supply tube 13 via a bendable flexible tube on a downstream side. The fuel filter 43 connected in the manner as above filters out fine foreign matter from fuel discharged from the fuel pump 42 into the filter case 430 and forced into the fuel supply tube 13 by using the filter element 431. Fuel filtered in the manner as above is supplied to the internal combustion engine through the fuel supply tube 13.

The pressure regulator 44 is disposed in the tank main body 21 and located on a side of the fuel pump 42. The pressure regulator 44 is connected to the filter case 430 in a portion where a fuel path to the fuel supply tube 13 is provided. The pressure regulator 44 regulates a pressure of fuel to be discharged from the fuel filter 43 to the fuel supply tube 13. The liquid-level sensor 45 is attached to an outer peripheral portion of the tank main body 21. The liquid-level sensor 45 is electrically connected to the metal terminals 140 of the electrical connector 14 via a bendable flexible wire. The liquid-level sensor 45 electrically connected in the manner as above outputs a detection signal of a liquid level in the fuel tank 2 to the external control circuit according to a rotational angle of an arm 451 which rotates in association with up and down motion of a float 450 floating on fuel in the fuel tank 2.

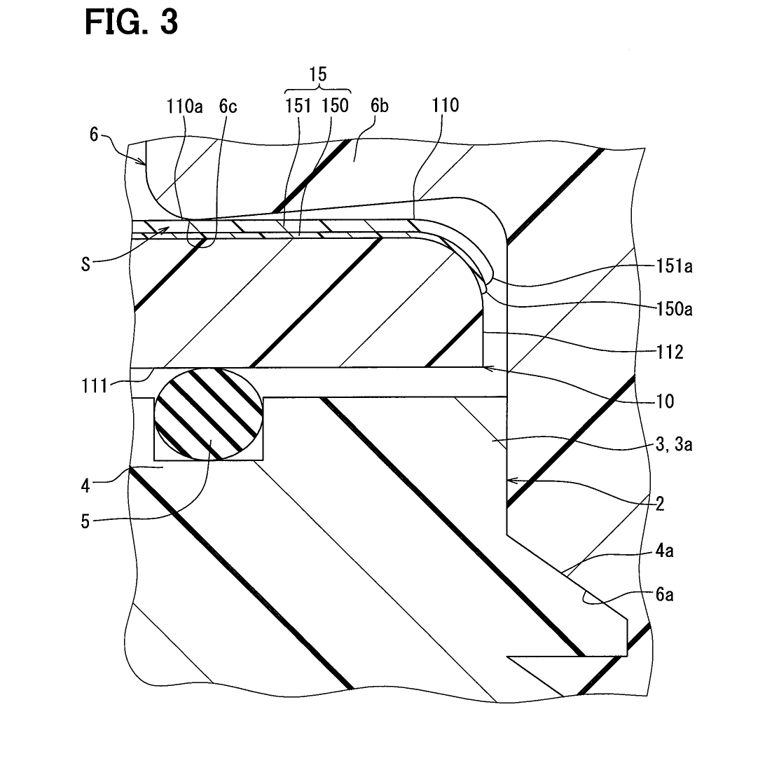

A detailed configuration will now be described. The tank lid 10 shown in FIGS. 2 and 3 is interposed between the inner flange portion 6b and the fixing seat portion 4 by screwing the fixed-side thread portion 6a into the tank-side thread portion 4a along an outer circumferential portion 112 of the lid main body 11. When the tank lid 10 is interposed in the manner as above, a bottom surface 6c as a fixed-side contact surface portion of the inner flange portion 6b is in contact with an outer-peripheral top surface portion 110a, which is a predetermined range of the top surface 110 of the lid main body 11 on an inner peripheral side of the outer circumferential portion 112. In other words, the outer-peripheral top surface portion 110a is in contact with the bottom surface 6c of the inner flange portion 6b as a lid-side contact surface portion provided at an interposing point S between the fixing member 6 and the tank wall 3. Herein, the outer-peripheral top surface portion 110a is provided to the lid main body 11 at the interposing point S, and by setting the interposing point S to the lid main body 11 on a periphery of a protruding point P of the reinforcing rib 12, the interposing point S becomes a point at which the elastic member 5 is in contact with the bottom surface 111 from an opposite side to the outer-peripheral top surface portion 110a.

Of a surface of the tank lid 10 shown in FIGS. 1 and 2, the top surface 110 of the lid main body 11 including the outer-peripheral top surface portion 110a, the base-side outer peripheral surface 131 of the fuel supply tube 13, and the outer peripheral surface 141 of the electrical connector 14 are formed of an acid-resistant coating film 15 as are shown in FIGS. 2 and 3. That is to say, the acid-resistant coating film 15 of the present embodiment is provided to the entire exposed outer surface made up of the surfaces 110, 131, and 141 and is therefore provided to at least the outer-peripheral top surface portion 110a.

As is shown in FIG. 3, the acid-resistant coating film 15 is formed by layering a primer film 150 in a lower layer and a main film 151 in an upper layer by sequentially applying two types of coating materials so as to form thin films. A base portion of the acid-resistant coating film 15 in the elements 11, 13, and 14 forming the tank lid 10 and the fixing member 6 are made of polyacetal resin (POM). In the present embodiment, in response to the fixing member 6 made of POM, the primer film 150 is made of a coating material based on polyester resin or alkyd resin whereas the main film 151 is made of a coating material based on fluorine resin. Owing to the resin materials selected for the respective films as above, bonding strength of the main film 151 to the base portion of the elements 11, 13, and 14 is increased by the primer film 150 between the base portion and the main film 151. In addition, surface free energy set to the top surface 110 including the outer-peripheral top surface portion 110a and the surfaces 131 and 141 all formed of the main film 151 of the acid-resistant coating film 15 is different from surface free energy set to the bottom surface 6c of the fixing member 6. Surface free energy set to the bottom surface 6c of the fixing member 6 is, for example, 21.5 mJ/m² whereas surface free energy set to the outer-peripheral top surface portion 110a formed of the main film 151 is, for example, 44.6 mJ/m².

Acid-resistance is conferred to the main film 151 exposed outside the fuel tank 2 so as to restrict breaking of molecular chains of POM taking place in the base portion of the elements 11, 13, and 14 due to an acid substance on the outside of the fuel tank 2. In consideration of acid resistance, bonding strength, and so on, a film thickness of the primer film 150 is set to, for example, about 5 μm whereas a film thickness of the main film 151 is set to, for example, about 25 μm. Further, an outer circumferential portion 151a of the main film 151 is layered on the primer film 150 on an inner peripheral side of an outer circumferential portion 150a of the primer film 150 so as not to be in direct contact with the base portion of the elements 11, 13, and 14.

An operational-effect of the fuel supply device 1 described above will now be described in the following.

According to the fuel supply device 1, the acid-resistant coating film 15 is provided to the tank lid 10 at least on the outer-peripheral top surface portion 110a in the surfaces 110, 131, and 141 making up the exposed outer surface exposed outside the fuel tank 2. Hence, high durability can be ensured at high productivity. Further, the outer-peripheral top surface portion 110a provided with the acid-resistant coating film 15 is in contact with the bottom surface 6c of the fixing member 6 screwed into the tank wall 3 along the outer circumferential portion 112 of the tank lid 10. By taking such contact into consideration, surface free energy different from surface free energy set to the bottom surface 6c is set to the acid-resistant coating film 15. Owing to the surface free energy set as above, the acid-resistant coating film 15 provided to the outer-peripheral top surface portion 110a is restricted from firmly fixing to the bottom surface 6c when the fixing member 6 is screwed into the tank wall 3. Hence, a slave rotation of the tank lid 10 to the fixing member 6 can be avoided. Consequently, a fastening force of the tank lid 10 can be ensured between the tank wall 3 and the fixing member 6, which can in turn restrict leakage of fuel vapor from a clearance between the tank lid 10 and the through-hole 4b. In addition, by fixing the tank lid 10 at a proper position in a circumferential direction and an up-down direction and thereby restricting positional displacement of the other elements 20, 30, and 40 forming the fuel supply device 1, a desired device property can be ensured. For example, a detection property of the liquid level in the fuel tank 2 can be ensured by restricting positional displacement of the liquid level sensor 45 of the pump unit 40.

According to the fuel supply device 1, a fastening force of the tank lid 10 directly acts on the tank lid 10 at the interposing point S set between the tank wall 3 and the fixing member 6. Hence, the acid-resistant coating film 15 provided to the outer-peripheral top surface portion 110a at the interposing point S is pressed against the bottom surface 6c of the fixing member 6 due to a fastening force generated when the fixing member 6 is screwed into the tank wall 3. However, even when the acid-resistant coating film 15 is pressed against the bottom surface 6c set with different surface free energy, the acid-resistant coating film 15 is hardly fixed firmly to the bottom surface 6c. A slave rotation of the tank lid 10 to the fixing member 6 can be thus avoided. Consequently, leakage of fuel vapor from a clearance between the tank lid 10 and the through-hole 4b can be restricted and also a desired device property can be ensured by properly locating the elements 10, 20, 30, and 40 forming the fuel supply device 1.

Further, according to the fuel supply device 1, the tank lid 10 made of a resin material having low elastic modulus generally induces an elastic restoring force by undergoing elastic deformation at the interposing point S between the tank wall 3 and the fixing member 6. In particular, in the lid main body 11 that is a plate shape and closes the through-hole 4b of the fuel tank 2, an elastic restoring force of the tank lid 10 is more readily induced at the interposing point S on the periphery of the protruding point P of the reinforcing rib 12 due to elastic deformation about the protruding point P as a fulcrum. The acid-resistant coating film 15 provided to the outer-peripheral top surface portion 110a at the interposing point S is thus pressed hard against the bottom surface 6c of the fixing member 6 due to a fastening force generated when the fixing member 6 is screwed into the tank wall 3 and an elastic restoring force induced by the tank lid 10. However, even when the acid-resistant coating film 15 is pressed hard against the bottom surface 6c set with different surface free energy, the acid-resistant coating film 15 exerts a function of restricting firm fixation to the bottom surface 6c in a reliable manner. A slave rotation of the tank lid 10 to the fixing member 6 can be thus avoided. Consequently, leakage of fuel vapor from a clearance between the tank lid 10 and the through-hole 4b can be restricted and also a desired device property can be ensured by properly locating the elements 10, 20, 30, and 40 forming the fuel supply device 1.

The elastic member 5 sealing a space between the tank lid 10 and the tank wall 3 is in contact with the tank lid 10 of the fuel supply device 1 from an opposite side to the outer-peripheral top surface portion 110a at the interposing point S between the tank wall 3 and the fixing member 6. Accordingly, an elastic restoring force is induced as the elastic member 5 undergoes elastic deformation. The acid-resistant coating film 15 provided to the outer-peripheral top surface portion 110a at the interposing point S is thus pressed hard against the bottom surface 6c of the fixing member 6 due to a fastening force generated when the fixing member 6 is screwed into the tank wall 3 and an elastic restoring force induced by the elastic member 5. However, even when the acid-resistant coating film 15 is pressed hard against the bottom surface 6c set with different surface free energy, the acid-resistant coating film 15 exerts a function of restricting firm fixation to the bottom surface 6c in a reliable manner. A slave rotation of the tank lid 10 to the fixing member 6 can be thus avoided. Consequently, leakage of fuel vapor from a clearance between the tank lid 10 and the through-hole 4b can be restricted and also a desired device property can be ensured by properly locating the elements 10, 20, 30, and 40 forming the fuel supply device 1.

The acid-resistant coating film 15 of the fuel supply device 1 is provided to the surface of the tank lid 10 on the entire exposed outer surface made up of the top surface 110 including the outer-peripheral top surface portion 110a and the surfaces 131 and 141. A portion of the tank lid 10 exposed outside the fuel tank 2 can be thus covered entirely by the acid-resistant coating film 15. Consequently, leakage of fuel vapor from a clearance between the tank lid 10 and the through-hole 4b can be restricted and also a desired device property can be ensured by properly locating the elements 10, 20, 30, and 40 forming the fuel supply device 1 while increasing durability in a reliable manner at high productivity.

### OTHER EMBODIMENTS

While the above has described one embodiment of the present disclosure, it should be appreciated that an interpretation of the present disclosure is not limited to the embodiment above and the present disclosure is also applicable to various other embodiments within a scope of the present disclosure.

More specifically, according to a first modification, at least a part of a base portion of elements 11, 13, and 14 may be made of a resin material other than POM or a metal material. According to a second modification, at least a part of the fixing member 6 may be made of a resin material other than POM or a metal material on a condition that surface free energy set to the bottom surface 6c as a fixed-side contact surface portion is different from surface free energy set to the outer-peripheral top surface portion 110a as a lid-side contact surface portion.

According to a third modification, the main film 151 of the acid-resistant coating film 15 may be made of a resin-based coating material other than a coating material based on fluorine resin on a condition that surface free energy set to the outer-peripheral top surface portion 110a as a lid-side contact surface portion is different from surface free energy set to the bottom surface 6c as a fixed-side contact surface portion. According to a fourth modification, the primer film 150 of the acid-resistant coating film 15 may be made of a resin-based coating material different from a coating material based on polyester resin or alkyd resin. According to a fifth modification, the acid-resistant coating film 15 may be formed of only the main film 151 having high bonding strength to a base portion of elements 11, 13, and 14 on a condition that surface free energy set to the outer-peripheral top surface portion 110a as a lid-side contact surface portion is different from surface free energy set to the bottom surface 6c as a fixed-side contact surface portion.

According to a sixth modification, the elastic member 5 may not be provided to the fuel tank 2. According to a seventh modification, the reinforcing rib 12 may not be provided to the tank lid 10. According to an eighth modification, an interposing point S at which to provide the outer-peripheral top surface portion 110a as a lid-side contact surface portion may be set to the lid main body 11 at a point far distant from a protruding point P of the reinforcing rib 12.

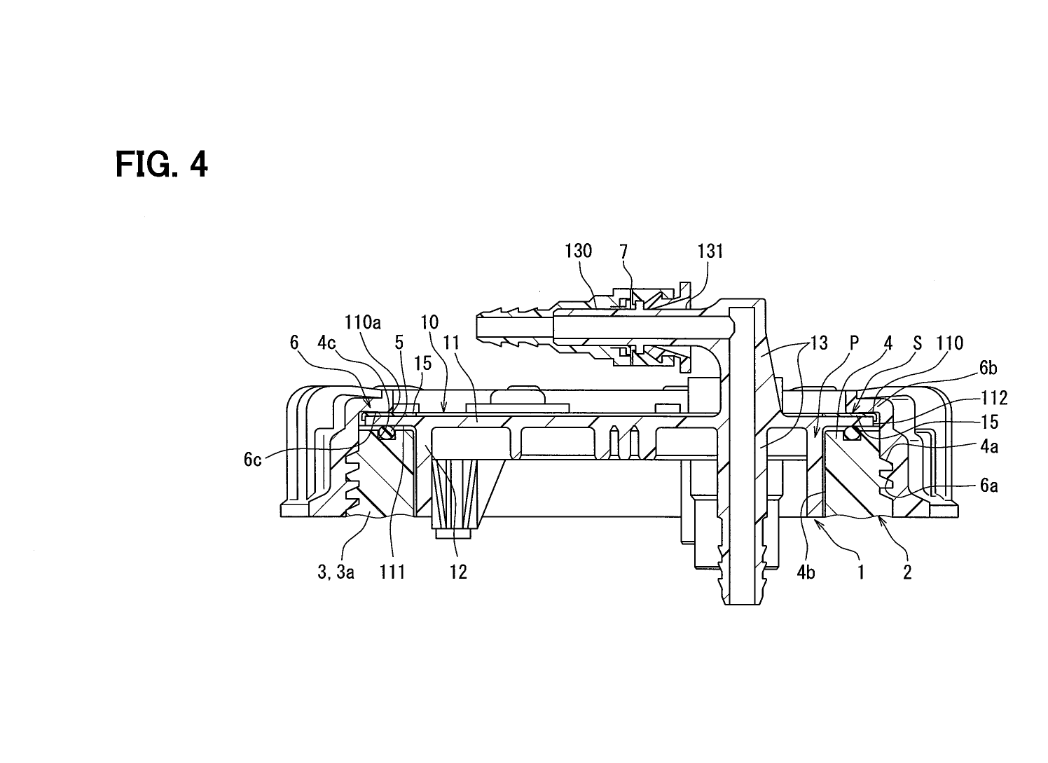

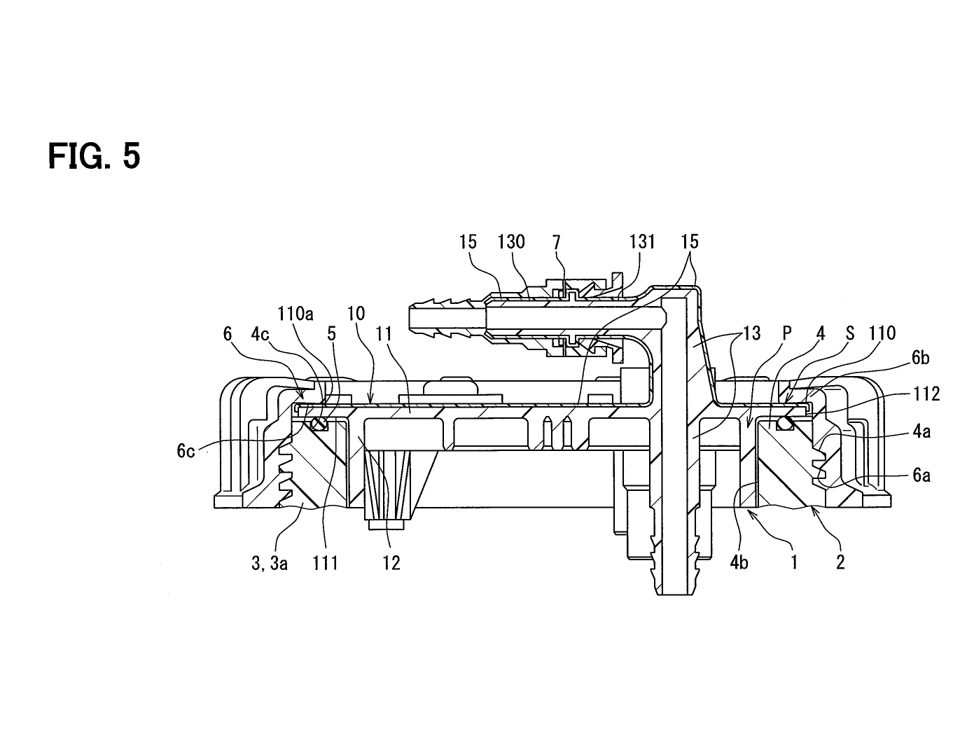

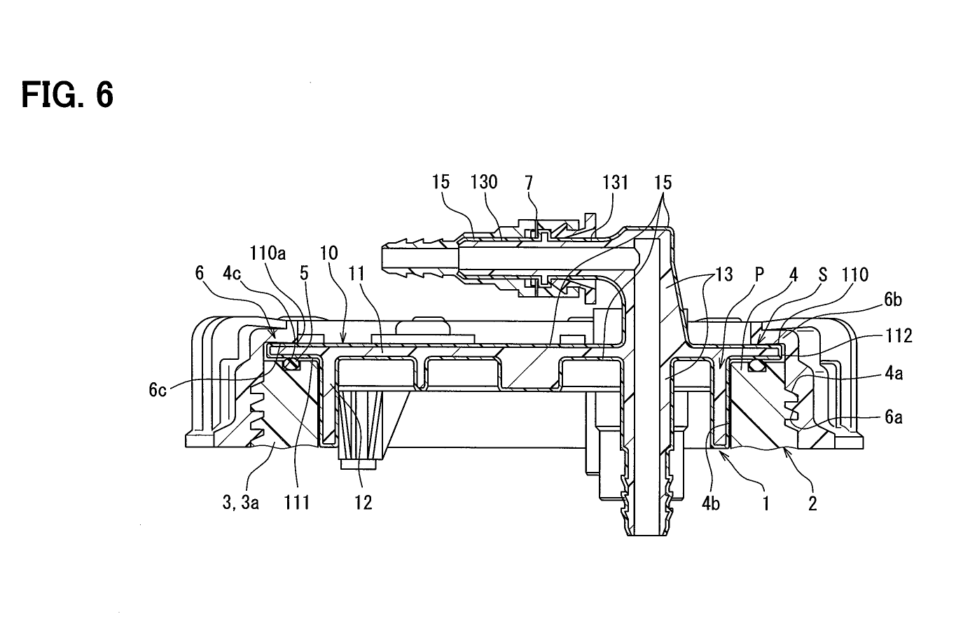

According to a ninth modification, the acid-resistant coating film 15 may be provided to a surface of the tank lid 10 only in the outer-peripheral top surface portion 110a as a lid-side contact surface portion. For instance, as in an example shown in FIG. 4, a surface to which to provide the acid-resistant coating film 15 may be limited to only the outer-peripheral top surface portion 110a of an exposed outer surface. Alternatively, as in examples shown in FIGS. 5 and 6, the acid-resistant coating film 15 may be provided also to the outer peripheral surface 130 on a tip-end of the fuel supply tube 13 in addition to surfaces 110, 131, and 141 making up the exposed outer surface. In the example shown in FIG. 6, in particular, the acid-resistant coating film 15 is provided to an entire surface of the tank lid 10 including the outer peripheral surface 130 and the bottom surface 111 in addition to the surfaces 110, 131, and 141 making up the exposed outer surface.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A fuel supply device provided with a tank lid closing a through-hole in a tank wall of a fuel tank and sending fuel in the fuel tank to an outside of the fuel tank when fixed to the fuel tank by interposing the tank lid between the tank wall and a fixing member, wherein
the tank lid has a lid-side contact surface portion which is in an exposed outer surface exposed outside the fuel tank and is in contact with a fixed-side contact surface portion of the fixing member screwed into the tank wall along an outer circumferential portion of the tank lid, and
the lid-side contact surface portion is provided with an acid-resistant coating film set with surface free energy different from surface free energy set to the fixed-side contact surface portion.

2. The fuel supply device according to claim 1, wherein
the acid-resistant coating film is provided in the lid-side contact surface portion at an interposing point set between the tank wall and the fixing member, in the tank lid.

3. The fuel supply device according to claim 2, wherein
the acid-resistant coating film is provided in the lid-side contact surface portion at the interposing point in the tank lid that is made of a resin material.

4. The fuel supply device according to claim 3, wherein
the tank lid has a lid main body that is a plate shape and closes the through-hole and a reinforcing rib that protrudes from the lid main body and reinforces the lid main body, and
the acid-resistant coating film is provided in the lid-side contact surface portion at the interposing point on a periphery of a protruding point of the reinforcing rib, in the lid main body.

5. The fuel supply device according to claim 2, wherein
the fuel supply device includes an elastic member sealing a space between the tank lid and the tank wall in an elastically deformed state by being in contact with the tank lid at the interposing point from an opposite side to the lid-side contact surface portion.

6. The fuel supply device according to claim 1, wherein
the acid-resistant coating film is provided on the entire exposed outer surface including the lid-side contact surface portion, in a surface of the tank lid.
